(19) United States
(12) Patent Application Publication
(10) Pub. No.: US 2018/0325775 A1
(43) Pub. Date: Nov. 15, 2018

(54) DUAL VIAL ADAPTER ASSEMBLAGE INCLUDING DRUG VIAL ADAPTER WITH SELF-SEALING ACCESS VALVE

(71) Applicant: West Pharma. Services IL, Ltd., Ra'anana (IL)

(72) Inventors: Uri DAVID, Nes Ziona (IL); Igor DENENBURG, Gedera (IL); Elisheva FABRIKANT, Herzliya (IL)

(21) Appl. No.: 15/775,250

(22) PCT Filed: Nov. 24, 2016
(86) PCT No.: PCT/IL16/51265

§ 371 Date: May 10, 2018

(30) Foreign Application Priority Data
Nov. 25, 2015 (IL) 242776
May 15, 2016 (IL) 245641

(51) Int. Cl. A61J 1/20

(52) U.S. Cl. CPC A61J 1/2089; A61J 1/2013; A61J 1/2096; A61J 1/2051; A61J 1/2037

(57) ABSTRACT

Dual vial adapter assemblage modified including a drug vial adapter having a female connector fitted with a normally closed needlefree swabable self-sealing access valve, a liquid vial adapter with a male connector and a manually operable flow control arrangement. The flow control arrangement has three operative positions including an initial extended set-up position, an intermediate compacted flow communication position and a final detachment position for separating the drug vial adapter and the liquid vial adapter. The liquid vial adapter and the drug vial adapter are engaged in the initial extended set-up position and the intermediate compacted flow communication position. The self-sealing access valve is closed in the initial extended set-up position and compressed open in the intermediate compacted flow communication position.

### FIELD OF THE INVENTION

The invention relates to dual vial adapter assemblages for use with a needleless syringe, a drug vial containing a medicament, and a liquid vial containing liquid contents.

### BACKGROUND OF THE INVENTION

Commonly owned U.S. Pat. No. 6,558,365 to Zinger et al. entitled Fluid Transfer Device discloses a dual vial adapter assemblage for use with a needleless syringe, a drug vial containing a medicament, and a liquid vial containing liquid contents. The drug vial is under negative pressure. The needleless syringe is preferably formed with a male Luer lock connector. The medicament can be in the form of a powder, solid or liquid. The liquid contents can be in the form of diluent only or alternatively include an active component. Dual vial adapter assemblages constructed and operative in accordance with U.S. Pat. No. 6,558,365 are commercially available from West Pharmaceutical Services, Inc., Exton, USA under the registered trademark MIX2VIAL.

U.S. Pat. No. 6,558,365 dual vial adapter assemblages include a drug vial adapter for telescopic mounting on a drug vial and a liquid vial adapter for telescopic mounting on a liquid vial and in initial releasable engagement with the drug vial adapter. The liquid vial adapter includes a male connector in flow communication with a liquid vial stopper puncturing cannula for puncturing a liquid vial stopper on telescopic mounting the liquid vial adapter on a liquid vial. The male connector is preferably a male Luer lock connector. The drug vial adapter includes a female connector in flow communication with a drug vial stopper puncturing cannula for puncturing a drug vial stopper on telescopic mounting the drug vial adapter on a drug vial. The female connector is preferably a female Luer connector with a screw thread for screw thread attachment of a male Luer lock connector thereon.

The use of U.S. Pat. No. 6,558,365 dual vial adapter assemblage is as follows: The dual vial adapter assemblage is provided in an initial flow communication position with the liquid vial adapter screw thread mounted on the drug vial adapter such that the liquid vial adapter's male connector is in flow communication with the drug vial adapter's female connector. The liquid vial adapter is telescopic mounted onto the liquid vial placed on a horizontal work table. The dual vial adapter assemblage is inverted ready for telescopic mounting the drug vial adapter on the drug vial placed on the horizontal work table with the liquid vial adapter above the drug vial adapter. On telescopic mounting the drug vial adapter on the drug vial, the negative pressure draws the liquid contents downward from the liquid vial into the drug vial for forming a liquid drug in the drug vial. The liquid vial adapter is unthreaded from the drug vial adapter and the needleless syringe is attached to its female connector ready for aspiration of the liquid drug from the drug vial to the needleless syringe. The entire liquid drug contents can be aspirated from the drug vial either in a single aspiration or two or more aspirations in quick succession. Subsequent aspirations after a prolonged detachment of the liquid vial adapter from the drug vial adapter is generally refrained due to concern of lack of sterility.

There is a need for a dual vial adapter assemblage for facilitating multiple aspirations of liquid drug dosages from a drug vial under sterile conditions after a prolonged detachment of a liquid vial adapter from a drug vial adapter.

### SUMMARY OF THE INVENTION

The present invention is directed towards a dual vial adapter assemblage similar to the aforementioned commonly owned U.S. Pat. No. 6,558,365. The present invention differs from the former insofar as the present invention includes a drug vial adapter with a female connector fitted with a normally closed needlefree swabable self-sealing access valve which can be selectively opened to a flow communication state on insertion of a male connector therein and a manually operable flow control arrangement. Such normally closed needlefree swabable self-sealing access valves are commercially available from inter alia Halkey Roberts, and the like. http://www.halkeyrobetts.com/products/medical/general.aspx.

The flow control arrangement has the following three operative positions: First, an initial extended set-up position in which the liquid vial adapter engages the drug vial adapter without the liquid vial adapter's male connector being inserted in the drug vial adapter's female connector such that its self-sealing access valve remains closed. Second, an intermediate compacted flow communication position for urging the liquid vial adapter's male connector into the female connector for compressing the self-sealing access valve into a flow communication state for enabling flow communication between the drug vial and the liquid vial for enabling formation of liquid drug contents in the drug vial. And third, a final detachment position for enabling detachment of the liquid vial adapter from the drug vial adapter thereby providing access to the self-sealing access valve for repeated aspirations of liquid drug contents from the drug vial.

The extended set-up position enables the dual vial adapter assemblage to be stored for its intended shelf life without concern regarding the normally closed self-sealing access valve becoming unfit for use due to prolonged storage in its compressed flow communication state which may deteriorate its self-sealing capability. The liquid vial adapter's male connector preferably contacts the self-sealing access valve so as to maintain its sterility during storage in the initial extended set-up position of the dual vial adapter assemblage. Accordingly, the dual vial adapter assemblage is ready to use on removal from its sterile packaging without the need to swab the self-sealing access valve prior to the first aspiration of liquid drug contents. Alternatively, the male connector can be spaced apart from the self-sealing access valve in the initial extended set-up position. Accordingly, the self-sealing access valve is maintained sterile by being covered by a manually removable label to be removed before use of the dual vial adapter assemblage.

The use of the dual vial adapter assemblage of the present invention is modified from the U.S. Pat. No. 6,558,365 dual vial adapter assemblage insofar as a user is required to initially dispose the dual vial adapter assemblage from its initial extended set-up position to its intermediate compacted flow communication position before forming liquid drug contents in a drug vial. The dual vial adapter assemblage of the present invention can be implemented such that the flow control arrangement requires either a manual linear compaction of a liquid vial adapter towards a drug vial adapter or a manual rotational compaction of a liquid vial adapter relative to a drug vial adapter for urging the flow control arrangement from its initial extended set-up position to its intermediate compacted flow communication position. Flow control arrangements can be implemented with different types of mechanical arrangements including hook member arrangements including at least one hook member, bayonet arrangements including at least one pin and groove pair, screw thread arrangements, and the like.

In the case of a flow control arrangement involving a linear compaction of a liquid vial adapter towards a drug vial adapter, a dual vial adapter assemblage can be preferably packaged in a blister for assisting a user to follow a prescribed set of instructions for use. The blister includes an internal rigid restrainer arrangement at its blister container open end for preventing immediate snap fit of a liquid vial adapter on a liquid vial on telescopic mounting of a liquid vial adapter on a liquid vial. The internal rigid restrainer arrangement can be provided as a discrete restrainer ring for mounting inside a blister container open end or alternatively can be an integral design feature. Suitable mountings include inter alia snap fits, gluing, and the like.

### BRIEF DESCRIPTION OF DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a pictorial view of an administration set including a needleless syringe, a drug vial, a liquid vial, and a blister including a dual vial adapter assemblage in its initial extended set-up position in accordance with a first embodiment of the present invention;

FIG. 2 is a first exploded perspective view of the blister and the dual vial adapter assemblage;

FIG. 3 is a second exploded perspective view of the blister and the dual vial adapter assemblage;

FIG. 4A is an exploded front elevation view of the dual vial adapter assemblage;

FIG. 4B is a longitudinal cross section of the dual vial adapter assemblage in FIG. 4A along line 4B-4B;

FIG. 4C is a longitudinal cross section of the dual vial adapter assemblage in its initial extended set-up position along line 4B-4B in FIG. 4A;

FIG. 4D is a longitudinal cross section of the dual vial adapter assemblage in its intermediate compacted flow communication position along line 4B-4B in FIG. 4A;

FIG. 5A is a front elevation view of the dual vial adapter assemblage in its extended set-up position in the blister and the liquid vial before telescopic mounting the dual vial adapter assemblage on the liquid vial;

FIG. 5B is a longitudinal cross section of the front elevation view in FIG. 5A along line 5B-5B;

FIG. 6A is a front elevation view of the dual vial adapter assemblage in the blister and the liquid vial adapter contacting the liquid vial;

FIG. 6B is a longitudinal cross sectional of the front elevation view in FIG. 6A along line 6B-6B;

FIG. 7A is a front elevation view showing the liquid vial urging the manual operable flow control arrangement into its intermediate compacted flow communication position on initial telescopic mounting the dual vial adapter assemblage thereon;

FIG. 7B is a longitudinal cross sectional of the front elevation view in FIG. 7A along line 7B-7B;

FIG. 8A is a front elevation view of the dual vial adapter assemblage in the blister with the liquid vial adapter puncturing the liquid vial;

FIG. 8B is a longitudinal cross sectional of the front elevation view in FIG. 8A along line 8B-8B;

FIG. 9A is a front elevation view showing removal of the dual vial adapter assemblage from the blister and inversion of the dual vial adapter assemblage for placement of the drug vial adapter on the drug vial without puncturing the drug vial;

FIG. 9B is a longitudinal cross section of the front elevation view in FIG. 9A along line 9B-9B;

FIG. 10A is a front elevation view showing the drug vial adapter puncturing the drug vial for withdrawing diluent from the liquid vial into the drug vial for forming liquid drug contents in the drug vial;

FIG. 10B is a longitudinal cross section of the front elevation view in FIG. 10A along line 10B-10B;

FIG. 11A is a front elevation view showing attachment of a syringe to the drug vial adapter for aspiration of liquid drug contents from the drug vial;

FIG. 11B is a longitudinal cross section of the front elevation view in FIG. 11A along line 11B-11B;

FIG. 12 is a perspective view of a dual vial adapter assemblage in its initial extended set-up position in accordance with a second embodiment of the present invention;

FIG. 13 is a perspective view of the FIG. 12 dual vial adapter assemblage in its intermediate compacted flow communication position;

FIG. 14 is a perspective view of a dual vial adapter assemblage in its initial extended set-up position in accordance with a third embodiment of the present invention;

FIG. 15 is an exploded view of the FIG. 14 dual vial adapter assemblage;

FIG. 16A is a front elevation view of the FIG. 14 dual vial adapter assemblage in its initial extended set-up position;

FIG. 16B is a longitudinal cross section of the FIG. 14 dual vial adapter assemblage in FIG. 16A along line 16B-16B;

FIG. 17A is a front elevation view of the FIG. 14 dual vial adapter assemblage in its intermediate compacted flow communication position;

FIG. 17B is a longitudinal cross section of the FIG. 14 dual vial adapter assemblage in FIG. 17A along line 17B-17B;

FIG. 18A is a front elevation view of a dual vial adapter assemblage in its initial extended set-up position in accordance with a fourth embodiment of the present invention;

FIG. 18B is a longitudinal cross section of the dual vial adapter assemblage in FIG. 18A along line 18B-18B;

FIG. 19A is a front elevation view of the FIG. 18A dual vial adapter assemblage in its compacted flow communication position; and

FIG. 19B is a longitudinal cross section of the dual vial adapter assemblage in FIG. 19A along line 19B-19B.

### DETAILED DESCRIPTION OF PREFERRED EMBODIMENTS OF THE INVENTION

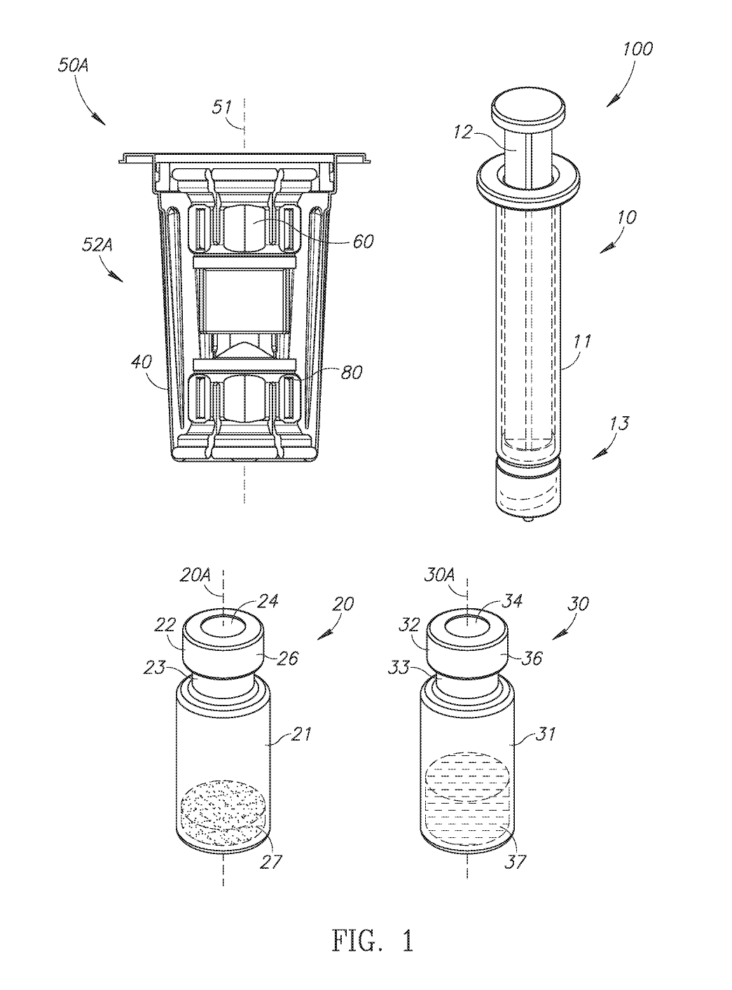

FIG. 1 shows an administration set 100 including an initially empty needleless syringe 10, a drug vial 20, a liquid vial 30, and a blister 40 for containing a dual vial adapter assemblage 50A. The needleless syringe 10 includes a barrel 11 with a plunger 12 and a male Luer lock connector 13. The syringe 10 can be formed with other types of male connectors. The drug vial 20 has a longitudinal drug vial axis 20A and includes an open topped drug vial bottle 21 having a drug vial crown 22 and a narrow diameter drug vial neck 23. The drug vial crown 22 is sealed by a drug vial stopper 24. The drug vial stopper 24 is sealed by an aluminum band 26. The drug vial 20 contains a medicament 27 in the form of a powder, solid or liquid. The drug vial 20 can be under negative pressure. The liquid vial 30 has a longitudinal liquid vial axis 30A and includes an open topped liquid vial bottle 31 having a liquid vial crown 32 and a narrow diameter liquid vial neck 33. The liquid vial crown 32 is sealed by a liquid vial stopper 34. The liquid vial stopper 34 is sealed by an aluminum band 36. The liquid vial 30 includes liquid contents 37 in the form of diluent only or an active component.

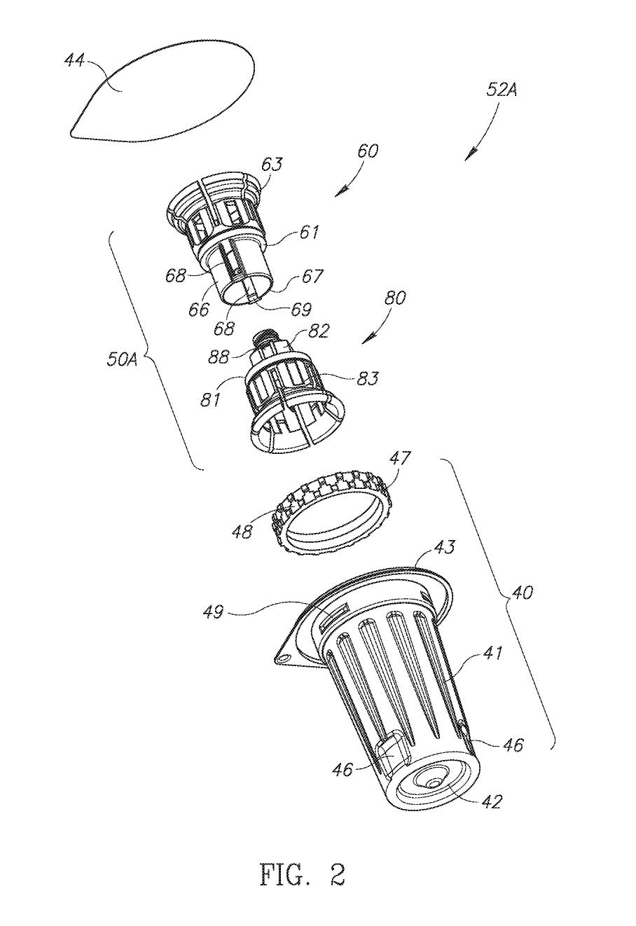

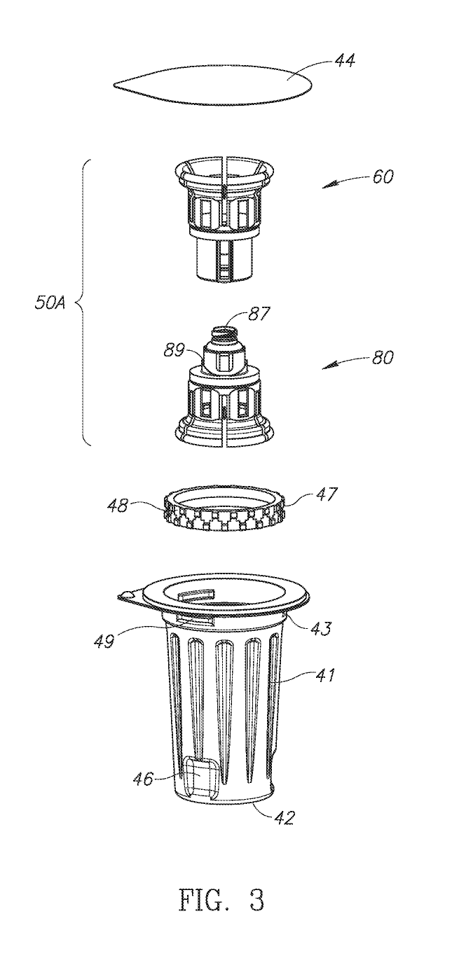

FIGS. 2 to 4 show the blister 40 includes an open ended blister container 41 having a blister container closed end 42 and a blister container open end 43. The blister 40 includes a seal 44 for sealing the open end 43. The blister container closed end 42 includes retainer indentations 46 for keeping the drug vial adapter 80 thereat. The open ended blister container 41 includes an internal rigid restrainer arrangement 47 at its open end 43 for preventing immediate snap fit of the liquid vial adapter 60 on the liquid vial 30 on the initial telescopic mounting of the liquid vial adapter 60 thereon. The internal rigid restrainer arrangement 47 is implemented as a discrete restrainer ring 48 which is snap fitted into place by indentations 49.

The dual vial adapter assemblage 50A has a longitudinal dual vial adapter assemblage centerline 51 and includes a liquid vial adapter 60 and a drug vial adapter 80 initially inter-engaged on the liquid vial adapter 60. The dual vial adapter assemblage 50A has a manual operable flow control arrangement 52A having three operative positions as follows: an initial extended set-up position, an intermediate compacted flow communication position and a final detachment position. Alternative drug vial adapter assemblages can be implemented with different flow control arrangements capable of assuming the intended three operative positions described hereinbelow.

The liquid vial adapter 60 includes a transverse liquid vial adapter top wall 61 with an upright male connector 62 and an opposite directed liquid vial adapter skirt 63 for telescopic mounting on the liquid vial 30. The male connector 62 is preferably a male Luer lock connector. The liquid vial adapter 60 further includes a liquid vial stopper puncturing cannula 64 for puncturing the liquid vial stopper 34 on telescopic mounting the liquid vial adapter 60 on the liquid vial 30. The upright male connector 62 is in flow communication with the liquid vial stopper puncturing cannula 64. The restrainer ring 48 has an internal diameter dimensioned to snugly receive the liquid vial adapter skirt 63 in its non-flexed position and prevents the opening of the liquid vial adapter skirt 63 for snap fitting on the liquid vial 30.

The liquid vial adapter 60 further includes an upright cylindrical sleeve 66 mounted on the transverse liquid vial adapter top wall 61 and encircling the upright male connector 62. The upright cylindrical sleeve 66 has a leading sleeve rim 67 facing the drug vial adapter 80. The cylindrical sleeve 66 is thin walled so that it can resiliently elastically deformed from a non-flexed cylindrical cross section to a slightly deformed elliptical cross section. The cylindrical sleeve 66 has a diametric pair of longitudinal directed closed end elongated slits 68 extending from the transverse liquid vial adapter top wall 61 to the leading sleeve rim 67. The leading sleeve rim 67 has a diametric pair of inward directed hook members 69 aligned with the diametric pair of longitudinal directed closed end elongated slits 68.

The drug vial adapter 80 includes a transverse drug vial adapter top wall 81 with an upright female connector 82 and an opposite directed drug vial adapter skirt 83 for telescopic mounting on the drug vial 20. The female connector 82 is preferably a female Luer connector. The drug vial adapter 80 further includes a drug vial stopper puncturing cannula 84 for puncturing the drug vial stopper 24 on telescopic mounting the drug vial adapter 80 on the drug vial 20. The upright female connector 82 is in flow communication with the drug vial stopper puncturing cannula 84. The upright female connector 82 is fitted with a needlefree swabable self-closing access valve 86 selectively compressible from an uncompressed normally closed state to a compressed flow communication state on a sealing insertion of a male connector therein. The needlefree swabable self-sealing access valve 86 includes a swabable pre-slit access surface 87.

The upright female connector 82 is formed with a diametric pair of longitudinal directed tracks 88 each having an upper track rim 89 and a lower track rim 91. The longitudinal directed tracks 88 are slightly longer than the height of the restrainer ring 48. The longitudinal directed tracks 88 diverge from their upper track rims 89 to their lower track rims 91 such that the lower track rims 91 are further distanced from the longitudinal dual vial adapter assemblage centerline 51 than the upper track rims 89. The upright female connector 82 is formed with a diametric pair of horizontal recesses 92 under the lower track rims 91 adjacent the transverse drug vial adapter top wall 81. The upright female connector 82 is formed with sloping escape ramps 93 on either side of the horizontal recesses 92 such that a manual rotation of the liquid vial adapter 60 relative to the drug vial adapter 80 releases the inward directed hook members 69 from the horizontal recesses 92 and causes them to ride up one of the sloping escape ramps 93 to distance the former 60 from the latter 80.

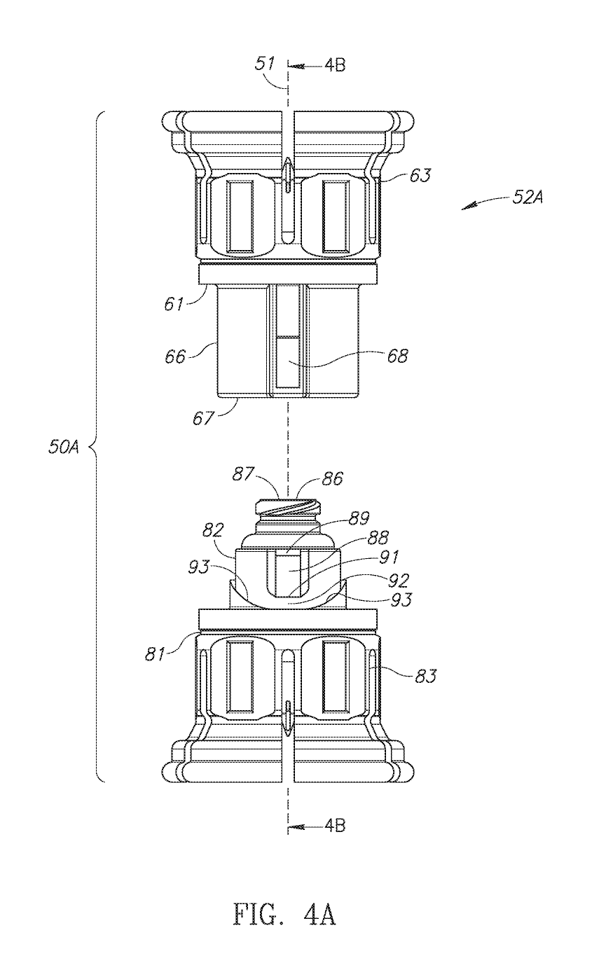

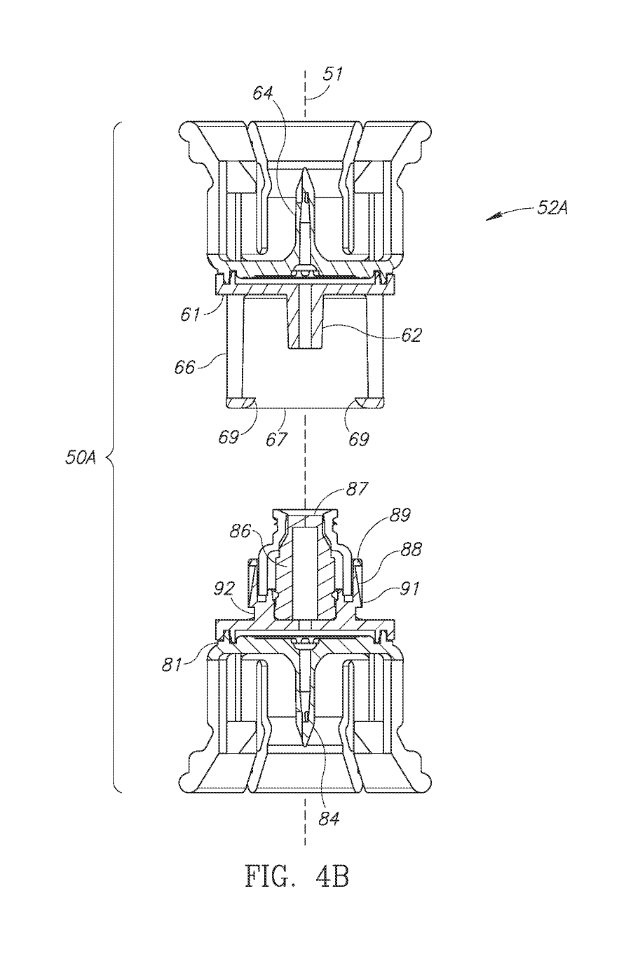

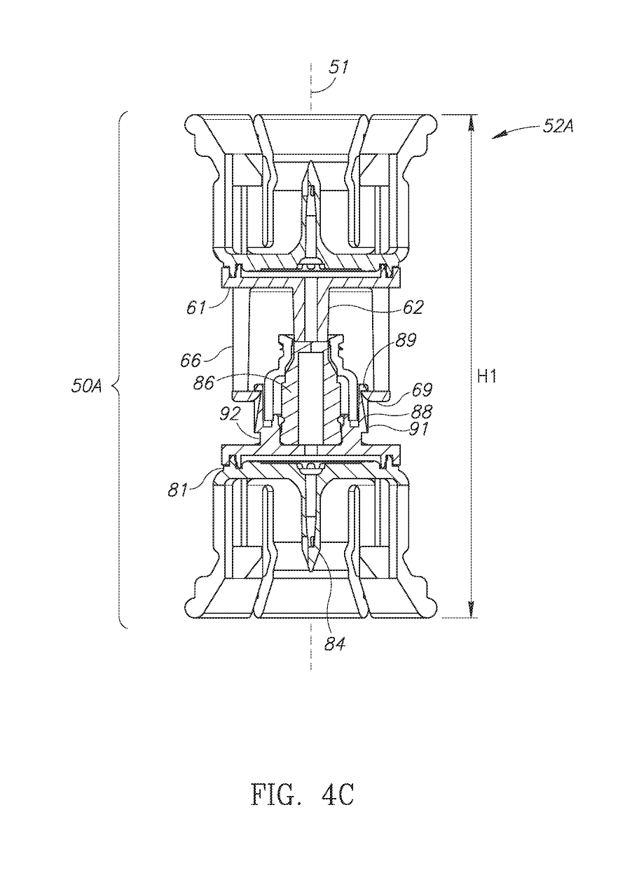

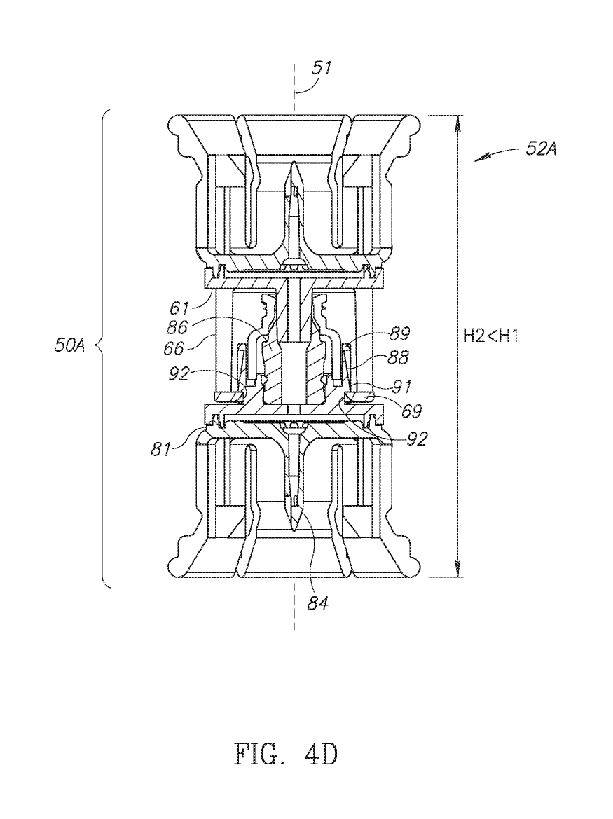

FIG. 4C shows the flow control arrangement 52A in its extended set-up position with the diametric pair of inward directed hook members 69 deployed at the upper track rims 89 for distancing the liquid vial adapter 60 from the drug vial adapter 80 such that the self-sealing access valve 86 is in its normal closed state suitable for long term storage. The male connector 62 contacts the swabable pre-slit access surface 87 but does not open the self-sealing access valve 86. The dual vial adapter assemblage 50A has an initial extended set-up position height H1.

FIG. 4D shows the flow control arrangement 52A in its intermediate compacted flow communication position after a linear compaction of the liquid vial adapter 60 towards the drug vial adapter 80. The inward directed hook members 88 are urged down the longitudinal directed tracks 88 and snap over the lower track rims 91 into the horizontal recess 92 thereby ensuring the liquid vial adapter 60 is in secure engagement with the drug vial adapter 80. At the same time, the male connector 62 is inserted into the female connector 82 to open the self-sealing access valve 86 for enabling liquid flow from a liquid vial 30 to a drug vial 20 for liquid drug formation purposes. The dual vial adapter assemblage 50A has an intermediate compacted flow communication position height H2 where H2<H1.

The flow control arrangement 52A has a final detachment position for enabling detachment of the liquid vial adapter 60 from the drug vial adapter 80 on a clockwise or counter clockwise rotation of the liquid vial adapter 60 relative to the drug vial adapter 80 thereby exposing the self-sealing access valve 86. Such release of the liquid vial adapter 60 from the drug vial adapter 80 involves slight elastic deformation of the thin walled cylindrical sleeve 66 from its non-flexed cylindrical cross section to its flexed elliptical cross section. The manual rotation of the liquid vial adapter 60 relative to the drug vial adapter 80 releases the inward directed hook members 69 from the horizontal recesses 92 and causes them to ride up one of the sloping escape ramps 93 to distance the former 60 from the latter 80. The self-sealing access valve 86 reverts to its normally closed state presenting the swabable pre-slit access surface 87.

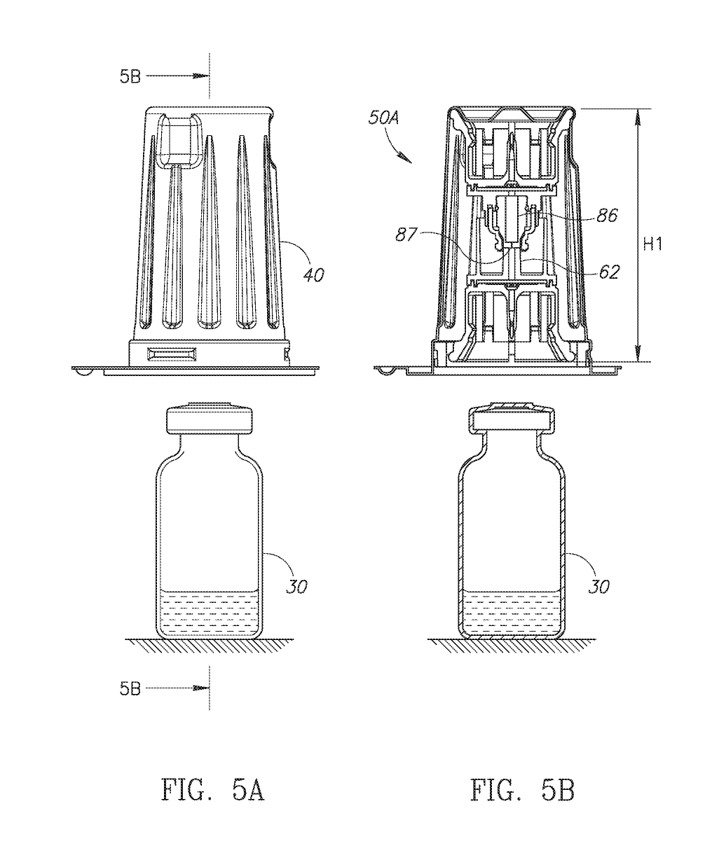

FIG. 5 to FIG. 11 show the use of the blister 40, the dual vial adapter assemblage 50A and a drug vial 20 under negative pressure. The dual vial adapter assemblage 50A can be equally used without the blister 40 and with a drug vial 20 not under negative pressure.

FIGS. 5A and 5B show the dual vial adapter assemblage 50A contained in the blister 40 and the liquid vial 30. The dual vial adapter assemblage 50A is in its initial extended set-up position having an initial extended set-up position height H1.

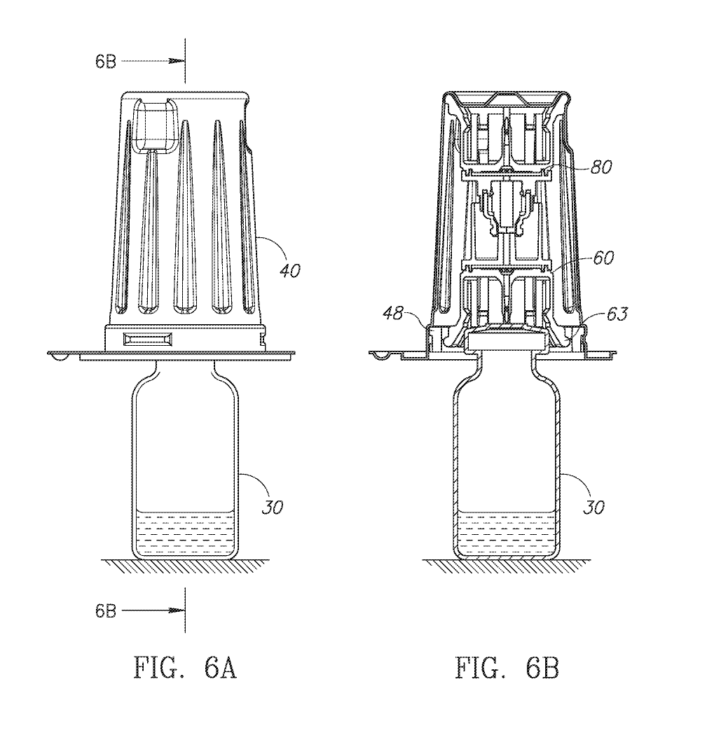

FIGS. 6A and 6B show the liquid vial adapter 60 contacting liquid vial 30.

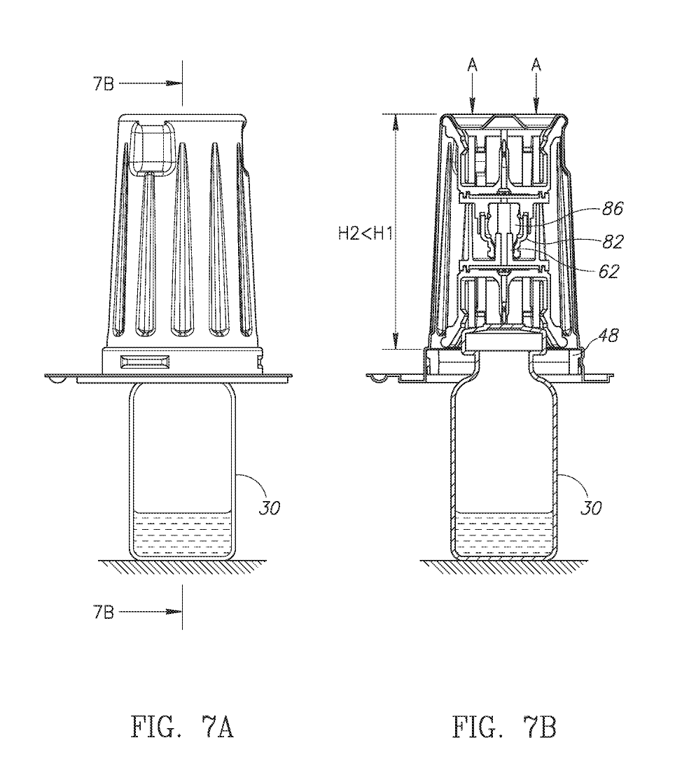

FIGS. 7A and 7B show a manual linear compaction force denoted by arrow A on the blister 40 for pushing the liquid vial adapter 60 onto the liquid vial 30 but the rigid restrainer ring 48 prevents the liquid vial adapter skirt 63 from opening. The manual linear compaction force urges the inward directed hook members 69 along the diametric pair of longitudinal tracks 88 over the lower track rims 91 into the diametric pair of horizontal recesses 92 on elastic deformation of the thin-walled cylindrical sleeve 66. The male connector 62 is inserted into the female connector 82 to fully longitudinally compress the self-sealing access valve 86 to its flow communication state for enabling flow communication between the liquid vial stopper puncturing cannula 64 and the drug vial stopper puncturing cannula 84. The liquid vial adapter 60 clears the restrainer ring 48. The dual vial adapter assemblage 50A has an intermediate compacted flow communication position height H2 where H2<H1.

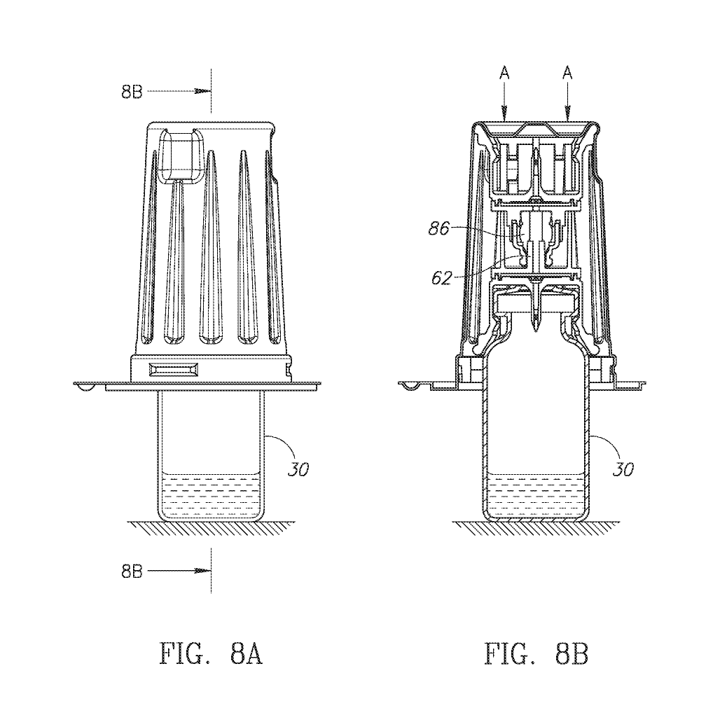

FIGS. 8A and 8B show continued linear manual compaction force further pushes the liquid vial adapter 60 onto the liquid vial 30 such that the liquid vial adapter 60 snap fits onto the liquid vial 30 thereby puncturing its liquid vial stopper 34.

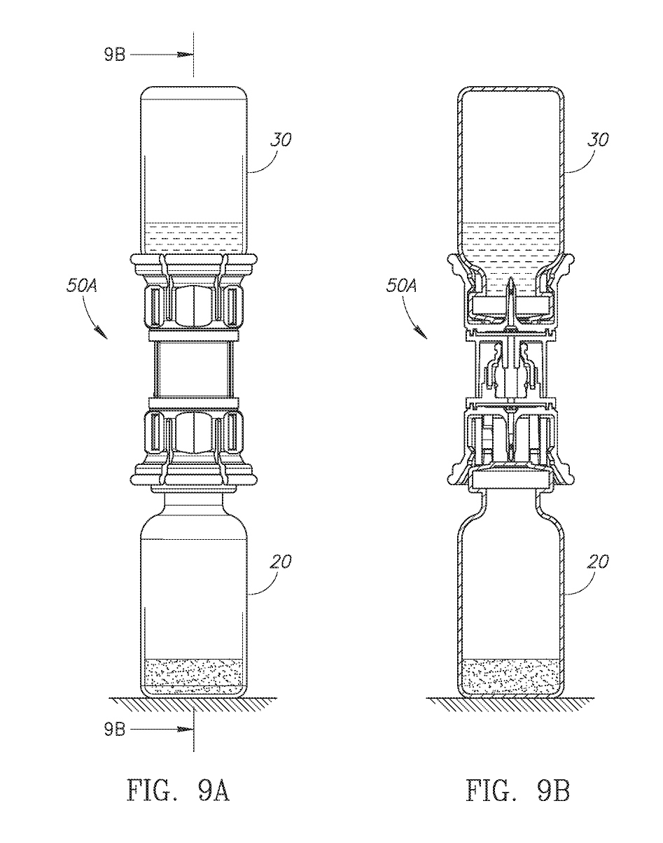

FIGS. 9A and 9B show removal of the dual vial adapter assemblage 50A from the blister 40 and inversion of the dual vial adapter assemblage 50A for placement of the drug vial adapter 80 on the drug vial 20 without puncturing same.

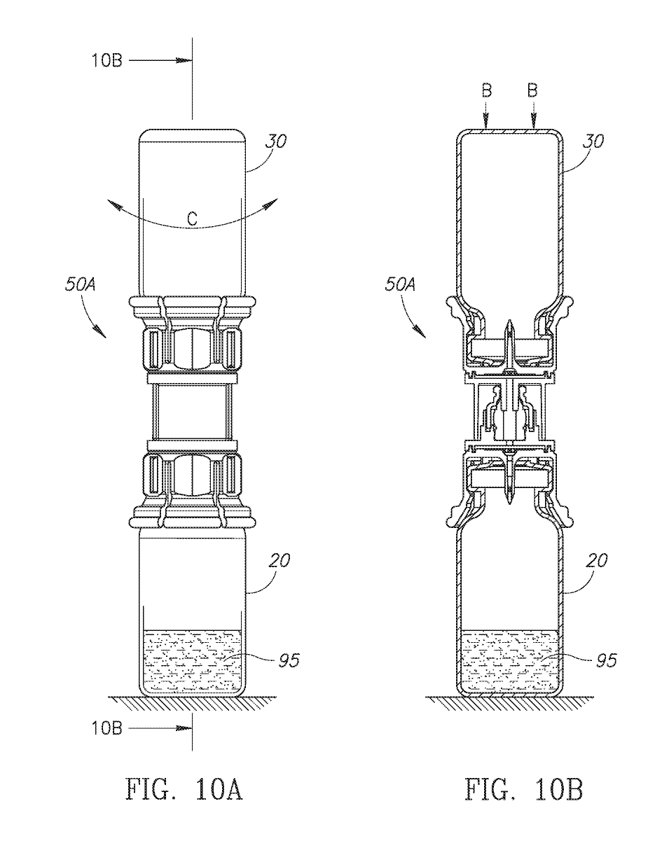

FIGS. 10A and 10B show a manual linear compaction force denoted by arrow B on the liquid vial 30 for pushing the drug vial adapter 80 onto the drug vial 20 for puncturing same. The drug vial 20 under negative pressure withdraws the liquid contents from the liquid vial 30 thereinto the drug vial 20 for formation of liquid drug contents 95 therein. The liquid vial 30 is now empty and the drug vial 20 now contains liquid drug contents 95.

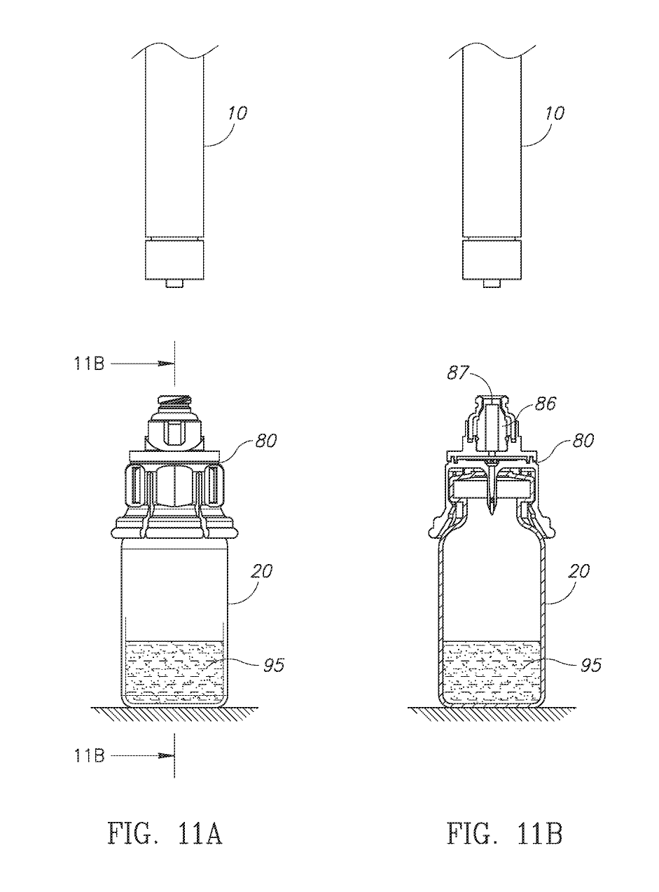

FIGS. 11A and 11B show the drug vial adapter 80 is ready for syringe aspiration of liquid drug 95 from the drug vial 20 after detachment of the liquid vial adapter 60 and the empty liquid vial 30 from the drug vial adapter 80 by either clockwise or counterclockwise rotation of the liquid vial adapter 60 relative thereto as denoted by arrow C in FIG. 10A.

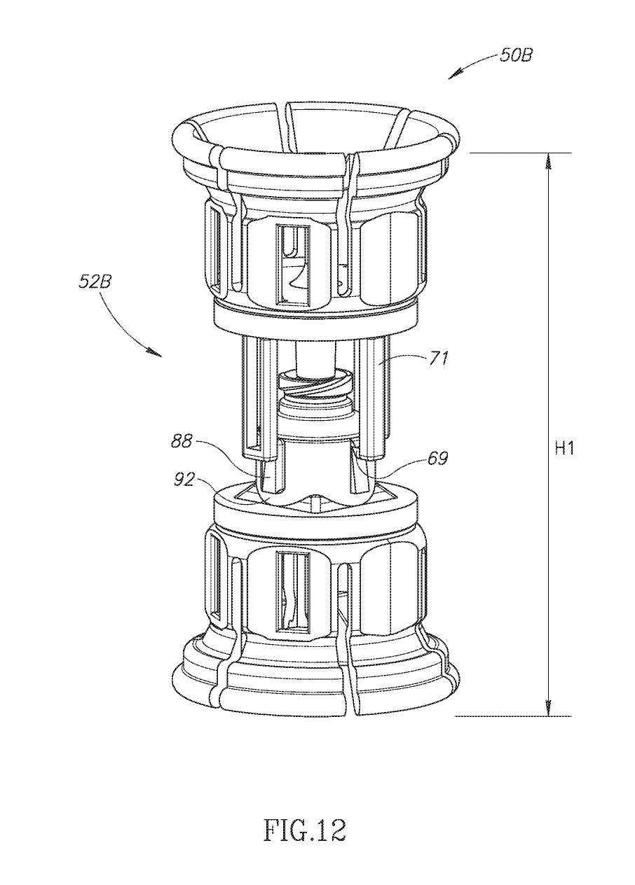

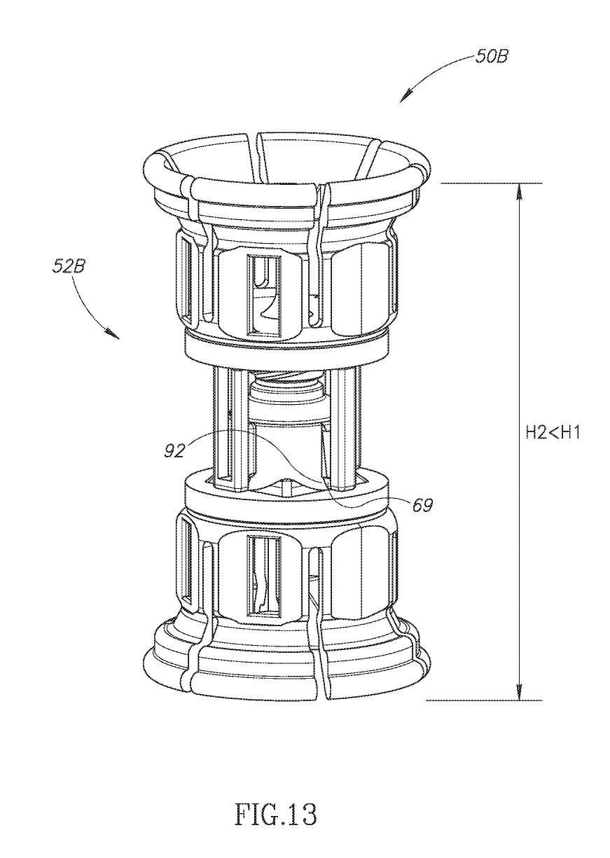

FIGS. 12 and 13 show a dual vial adapter assemblage 50B having a construction and operation similar to the dual vial adapter assemblage 50A and therefore similar parts are likewise numbered. The latter 50B differs from the former 50A insofar as the latter 50B has a manual operable flow control arrangement 52B having four equispaced longitudinally directed resiliently flexible supports 71 each having an inward directed hook member 69. Accordingly, the manual operable flow control arrangement 52B has a corresponding number of longitudinal directed tracks 82 each having its upper track rim 89, lower track rim 91, and horizontal recess 92.

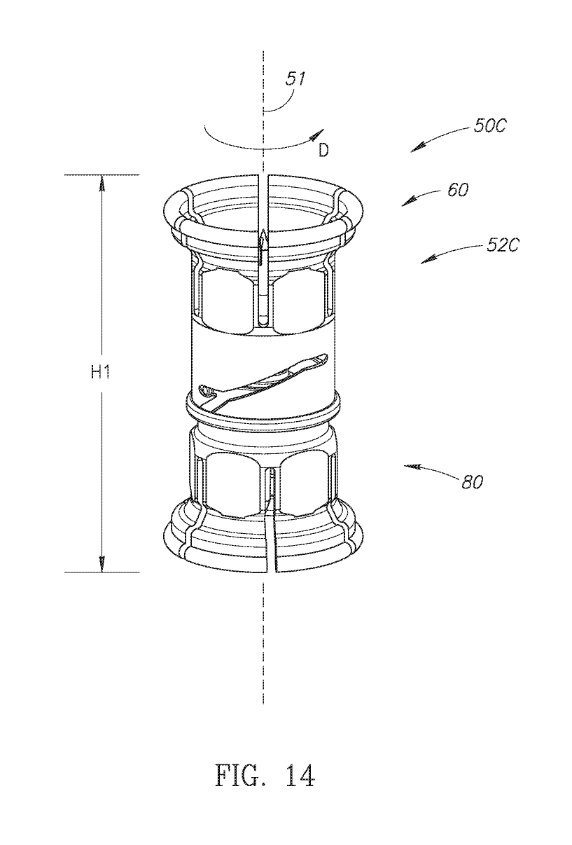

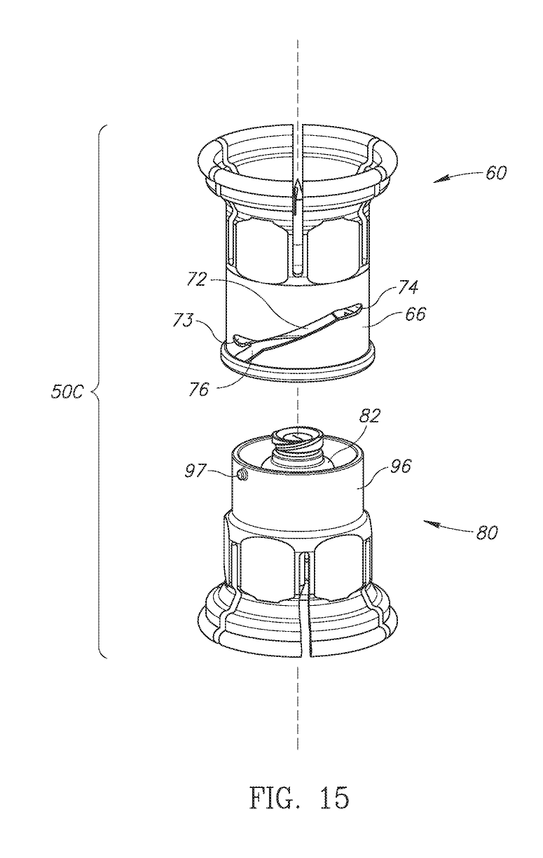

FIGS. 14 to 17 show a dual vial adapter assemblage 50C having a construction and operation similar to the dual vial adapter assemblage 50A and therefore similar parts are likewise numbered. The latter 50C differs from the former 50A insofar that the latter 50C has a manual operable flow control arrangement 52C in the form of a bayonet arrangement including at least one pin and groove pair and preferably a diametric pair of a pin and groove pair. The flow control arrangement 52C is urged from an initial extended set-up position to an intermediate compacted flow communication position on undergoing a rotational compaction as opposed to a linear compaction.

The liquid vial adapter 60 is formed with an upright cylindrical sleeve 66 with a diametric pair of Y-shaped grooves 72. The generally Y-shaped grooves 72 each include a first closed end 73, a second closed end 74 opposite the first closed end 73, and an open end 76 adjacent the closed end 73. The drug vial adapter 80 is formed with an upright cylindrical sleeve 96 encircling the female connector 82. The upright cylindrical sleeve 96 is shaped and dimensioned to be telescopically received within the upright cylindrical sleeve 66 on disposing the dual vial adapter assemblage 50C from its initial extended set-up position to its intermediate compacted flow communication position. The upright cylindrical sleeve 96 is formed with a diametric pair of outward directed pins 97 for sliding along the Y-shaped grooves 72. The pins 97 are located at the first closed ends 73 at the initial extended set-up position, the second closed ends 74 at the intermediate compacted flow communication position and the open ends 76 at the detachment position.

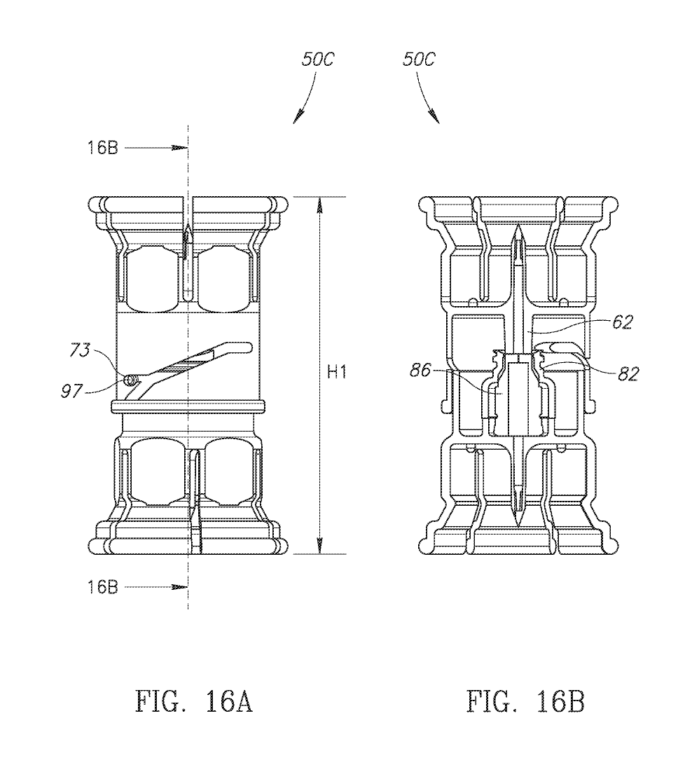

The flow control arrangement 52C has the following three positions: FIGS. 16A and 16B show the initial extended set-up position in which the dual vial adapter assemblage 50C has the initial extended set-up position height H1. The liquid vial adapter 60 engages the drug vial adapter 80 without the male connector 62 being inserted into the female connector 82 such that the self-sealing access valve 86 remains closed. The pins 97 are located at the first closed ends 73.

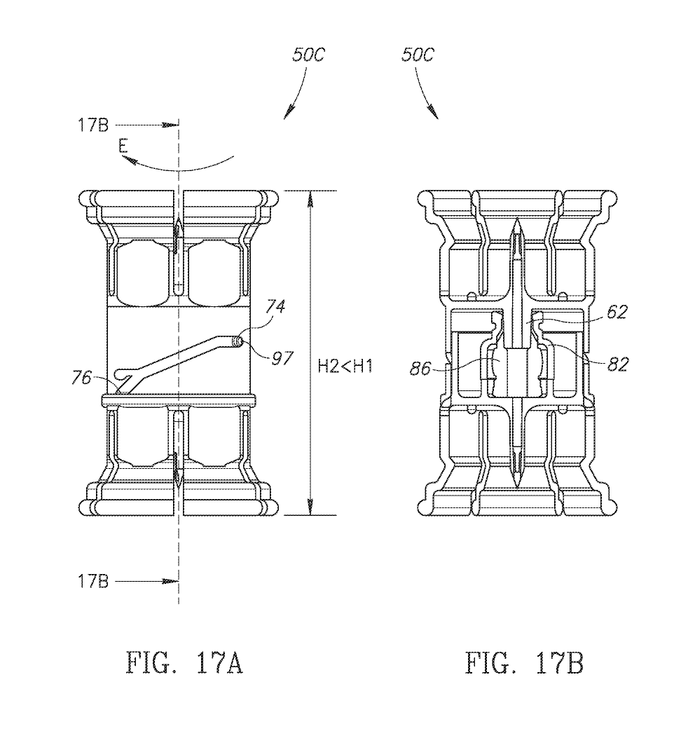

FIGS. 17A and 17B shows the intermediate compacted flow communication position in which the dual vial adapter assemblage 50C has the intermediate compacted flow communication position height H2. The liquid vial adapter 60 engages the drug vial adapter 80 for urging the male connector 62 into the female connector 82 to longitudinally compress the self-sealing access valve 86 to open same. The pins 97 are located at the second closed ends 74 after clockwise rotation of the liquid vial adapter 60 relative to a stationary drug vial adapter 80 around the longitudinal dual vial adapter assemblage centerline 51 as denoted by arrow D in FIG. 14.

A final detachment position for enabling detachment of the liquid vial adapter 60 from the drug vial adapter 80 on counterclockwise rotation of the liquid vial adapter 60 relative thereto around the longitudinal dual vial adapter assemblage centerline 51 as denoted by arrow E in FIG. 17A. The pins 97 are located at the open ends 76 for detachment purposes.

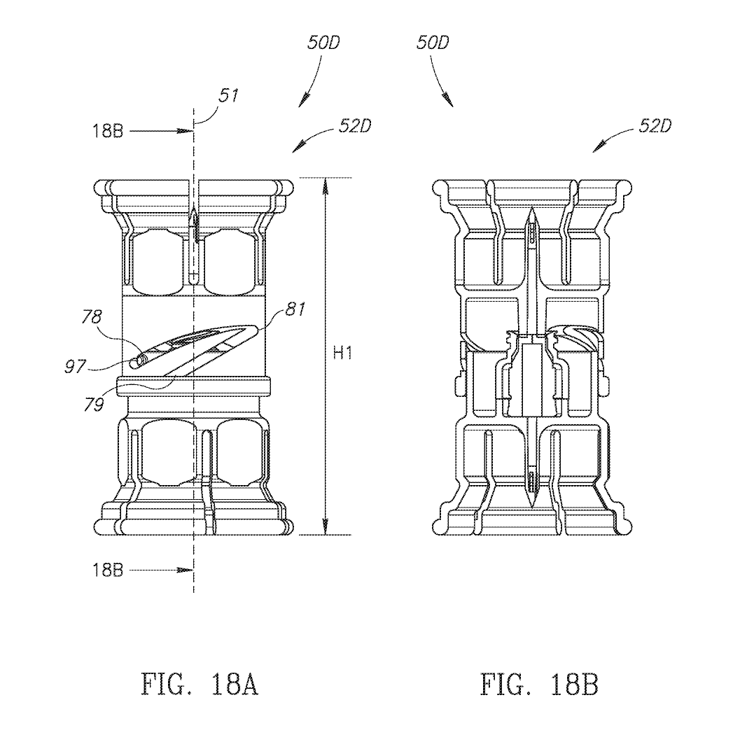

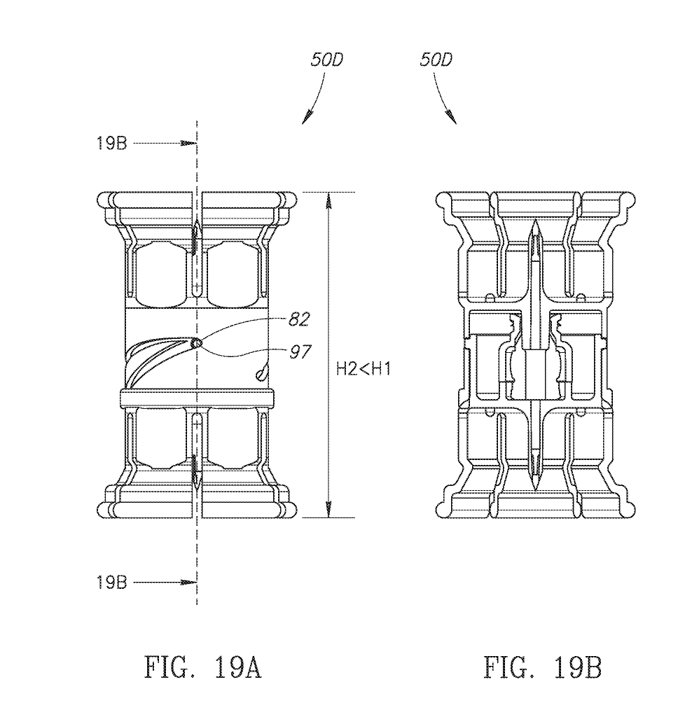

FIGS. 18 and 19 show a dual vial adapter assemblage 50D similar in construction and operation as the dual vial adapter assemblage 50C and therefore similar parts are likewise numbered. The flow control arrangement 52D is also urged from an initial extended set-up position to an intermediate compacted flow communication position on undergoing a rotational compaction as opposed to a linear compaction. The dual vial adapter assemblage 50D has a manual operable flow control arrangement 52D which differs from the manual operable flow control arrangement 52C insofar as the latter 50D includes a diametric pair of inverted inclined generally U-shaped grooves 77 instead of the diametric pair of Y-shaped grooves 72. The inverted inclined generally U-shaped grooves 77 each include a closed end 78, an open end 79 and a curved apex 81 between the closed end 78 and the open end 79. The pins 97 are located at the closed ends 78 at the initial extended set-up position, the curved apices 81 at the intermediate compacted flow communication position and the open ends 79 at the final detachment position.

While particular embodiments of the present invention are illustrated and described, it would be obvious to those skilled in the art that various other changes and modifications can be made without departing from the spirit and scope of the invention.

1.-10. (canceled)

11. A dual vial adapter assemblage for use with a needleless syringe having a male connector, a drug vial, and a liquid vial, the drug vial having a drug vial bottle and a drug vial stopper sealing the drug vial bottle, the drug vial containing a medicament, the liquid vial having a liquid vial bottle and a liquid vial stopper sealing the liquid vial bottle, the liquid vial containing liquid contents for mixing or reconstituting the medicament in the drug vial to form liquid drug contents therein, the dual vial adapter assemblage having a longitudinal dual vial adapter assemblage centerline and comprising:
(a) a drug vial adapter including a transverse drug vial adapter top wall with an upright female connector, an oppositely directed drug vial adapter skirt for telescopic mounting on the drug vial, and a drug vial stopper puncturing cannula for puncturing the drug vial stopper on said telescopic mounting said drug vial adapter on the drug vial, said upright female connector being in flow communication with said drug vial stopper puncturing cannula, said upright female connector having a needlefree swabable self-sealing access valve selectively longitudinal compressible from an uncompressed normally closed state to a compressed open flow communication state on a sealing insertion of a male connector therein;
(b) a liquid vial adapter including a transverse liquid vial adapter top wall with an upright male connector, an oppositely directed liquid vial adapter skirt for telescopic mounting on the liquid vial and a liquid vial stopper puncturing cannula for puncturing the liquid vial stopper on said telescopic mounting said liquid vial adapter on the liquid vial, said upright male connector being in flow communication with said liquid vial stopper puncturing cannula; and
(c) a manual operable flow control arrangement having two operative positions including:
i) a compacted flow communication position in which said liquid vial adapter engages said drug vial adapter with said male connector being urged into said female connector to longitudinally compress said self-sealing access valve to said open flow communication state for enabling flow communication between said drug vial stopper puncturing cannula and said liquid vial stopper puncturing cannula for enabling formation of the liquid drug in the drug vial and wherein the dual vial adapter assemblage has a compacted flow communication position height H2; and
ii) a final detachment position for enabling detachment of said liquid vial adapter from said drug vial adapter thereby providing repeatable access to said self-sealing access valve for aspiration of liquid drug contents from the drug vial,
characterised in that
the manual operable flow control arrangement has a further operative position comprising an initial extended set-up position in which said liquid vial adapter engages said drug vial adapter without said male connector being inserted into said female connector whereby said self-sealing access valve is closed and wherein the dual vial adapter assemblage has an initial extended set-up position height H1 where H2<H1, thereby said compacted flow communication position is an intermediate compacted flow communication position between said initial extended set-up position and said final detachment position.

12. The assemblage according to claim 11 wherein said flow control arrangement undergoes a linear compaction from said extended set-up position to said compacted flow communication position for urging said male connector into said female connector.

13. The assemblage according to claim 12 wherein said liquid vial adapter includes at least one inward directed hook member for sliding down an associated longitudinal track on said drug vial adapter during said linear compaction.

14. The assemblage according to claim 13 wherein said liquid vial adapter includes an upright cylindrical sleeve surrounding said male connector and said upright cylindrical sleeve is formed with said at least one inward directed hook member.

15. The assemblage according to claim 12 and further comprising a blister for containing the dual vial adapter assemblage, said blister including an open topped blister pack having a blister container closed end and a blister container open end, said blister container open end having an internal rigid restrainer arrangement for preventing immediate snap fit of said liquid vial adapter on the liquid vial on said telescopic mounting said liquid vial adapter on the liquid vial such that said telescopic mounting initially urges said flow control arrangement from said initial extended set-up position to said intermediate compacted flow communication position.

16. The assemblage according to claim 11 wherein said flow control arrangement undergoes a rotational compaction from said extended set-up position to said compacted flow communication position for urging said male connector into said female connector.

17. The assemblage according to claim 16 wherein said flow control arrangement is a bayonet arrangement having at least one pin groove pair in which a pin travels along an associated generally Y-shaped groove from a first closed end at said initial extended set-up position to a second closed end opposite said first closed end at said intermediate compacted flow communication position and from said second closed end at said intermediate compacted flow communication position to an open end at said final detachment position.

18. The assemblage according to claim 16 wherein said flow control arrangement is a bayonet arrangement having at least one pin groove pair in which a pin travels along an associated inverted inclined generally U-shaped groove from a first closed end at said initial extended set-up position to a curved apex at said intermediate compacted flow communication position and from said curved apex at said intermediate compacted flow communication to an open end at said final detachment position.

19. The assemblage according to claim 11 wherein said flow control arrangement employs a manual rotation of said liquid vial adapter relative to said drug vial adapter for disengaging said liquid vial adapter from said drug vial adapter at said final detachment position.

20. The assemblage according to claim 11 wherein, in said initial extended set-up position, said male connector contacts said self-sealing access valve without longitudinally compressing same.
